(19) United States
(12) Patent Application Publication
(10) Pub. No.: US 2003/0217267 A1
(43) Pub. Date: Nov. 20, 2003

(54) Authenticating a web hyperlink associated with a physical object

(76) Inventor: Timothy P.J.G. Kindberg, Burlingame, CA (US)

Correspondence Address: HEWLETT-PACKARD COMPANY, Intellectual Property Administration, P.O. Box 272400, Fort Collins, CO, 80527-2400, US

(21) Appl. No.: 10/147,194

(22) Filed: May 16, 2002

(51) Int. Cl. H04L 9/00

(52) U.S. Cl. 713/168

(57) ABSTRACT

A system and methodology associated with identifying physical objects using computer network technology. Objects having electronically obtainable identifiers include a URL associated with the identifier that is to a web page of identifying material associated the corresponding object. The identifying material may include hyperlinks to the Internet. Authentication for hyperlinks from physical entities to web resources is provided. One embodiment is a system for authenticating an https-URL hyperlink associated with a physical object, including: an indentifier mechanism allied with the physical object, having an output signal; and associated with said output signal, a web page providing identifying material associated with the physical object along said hyperlink associated therewith, wherein only a designated set of certificates limited to actual physical location of said physical object to authenticate the https-URL.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO AN APPENDIX

Not Applicable.

### BACKGROUND

1. Field of Technology

The field of technology relates generally to computer networks.

2. Description of Related Art

In the state-of-the-art, the user's experience of Internet-relational, mobile computing consists largely of being able to read e-mail or browse the web from a laptop computer, personal digital assistant (PDA), mobile telephone, or the like, referred to hereinafter generically as “mobile devices.” Even the most mundane of these activities are frequently hampered by the need for making configuration settings, waiting for connections, losing wireless connection signals and starting over, and the like.

Task-focused, sensor-enhanced, mobile devices are those that have tools for capturing some type of data or content from the physical world. For example, a PDA might be enhanced by addition of data capture tools, e.g., sensors such as an optical tag compatible subsystem—generally known as a barcode reader—an infrared receiver, a contact tag, a Radio Frequency Identification (RFID) tag reader, a position locator—such as Global Positioning System (GPS)—a camera, a handheld scanner, environmental condition detectors, a microphone and recording memory, or the like. Identifiers compatible with these capture tools, e.g., bar codes, beacons—namely, a transmitter of an identifier signal, e.g. a Internet Uniform Resource Locator (URL), over a short range via an infrared, wireless, or the like mechanism—and the like, are provided to be extracted from, attached to, or be near, associated physical objects. The capture tool obtains the identifier. The device resolves the identifier into a virtual resource or action related to the associated physical object. The result of resolution of an identifier may be information, e.g., a web page, or a service provided to the device user, or an action in the local physical environment. Provided with an appropriate infrastructure, mobile device users now automatically can find web links by sensing something in the physical world; i.e., mobile computing solutions use an iconic physical interface sensed by a sensor-enhanced mobile device and mapped by network software to a name for a contextual action associated with the current need.

Examples are described by J. Barton and present inventor T. Kindberg in HPL-2001-18 Technical Report, titled The Challenges and Opportunities of Integrating the Physical World and Network Systems, Jan. 24, 2001, discussing physical entities, virtual entities, and network-based linage mechanisms between them, whereby users engage simultaneously in mobile computing and their familiar physical world. The ability to resolve identifiers should be ubiquitous in that users should be able to pick up identifiers and, as long as they are connected to a wireless network, have the identifiers resolved. Examples of identifier resolution are described by present inventor T. Kindberg in HPL-2001-95 Technical Report, titled Ubiquitous and Contextual Identifier Resolution for the Real-world Wide Web, Apr. 18, 2001, revised as HPL-2001-95R1 Technical Report, titled Implementing Physical Hyperlinks Using Ubiquitous Identifier Resolution, Mar. 26, 2002, focusing on choices for identifier encoding and associated contextual parameters.

At the boundary of the computing world and the physical world there are at least two characteristics of typical problems for such an infrastructure: (1) a need to regulate something in the user's physical environment that does not have a convenient physical interface, and (2) a poor match of a desktop computer as an alternative interface. One requirement is to securely establish that a proper, rather than bogus, link is asserted for each association, even though one of the associations is to a resource that is managed elsewhere. In other words, the association must be verified as being accurate, i.e., between the given physical object and, for example, a specific URL the owner has chosen for it and none other.

Moreover, authentication problems arise because technologies used to associate information such as a URL with a physical object are subject to tampering. Beacons can be moved, highjacked, or imitated; bar codes can be moved or corrupted, or the like problems, can occur. As one example, a malicious person might attempt to move hyperlink beacons from one physical object to another; a vandal could take a museum beacon from beside the Mona Lisa and place it by a Van Gogh. As another example, a malicious person might read a beacon, barcode, or the like identifier, and copy it to another identifier mechanism which could then be placed by a different physical object. As another example, a malicious person might attempt to generate spurious links and provide them to users surreptitiously.

### BRIEF SUMMARY

In a basic aspect, there is provided a means and methodology for authentication for hyperlinks from physical objects, or entities, to Internet resources.

The foregoing summary is not intended to be an inclusive list of all the aspects, objects, advantages and features of described embodiments nor should any limitation on the scope of the invention be implied therefrom. This Summary is provided in accordance with the mandate of 37 C. F. R. 1.73 and M.P.E.P. 608.01(d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIG. 1 is a schematic block diagram of a system for sensing hyperlinks.

FIG. 2A is a schematic illustration of physical objects having identifiers associated with hyperlink activities as shown in FIG. 1.

FIG. 2B is a schematic illustration of an exemplary physical object as shown in FIG. 2A associated with one embodiment of an object-hyperlink authentication mechanism of the present invention.

FIG. 3 is a flow chart diagramming operation of an embodiment of the present invention.

Like reference designations represent like features throughout the drawings. The drawings referred to in this specification should be understood as not being drawn to scale except if specifically annotated.

### DETAILED DESCRIPTION

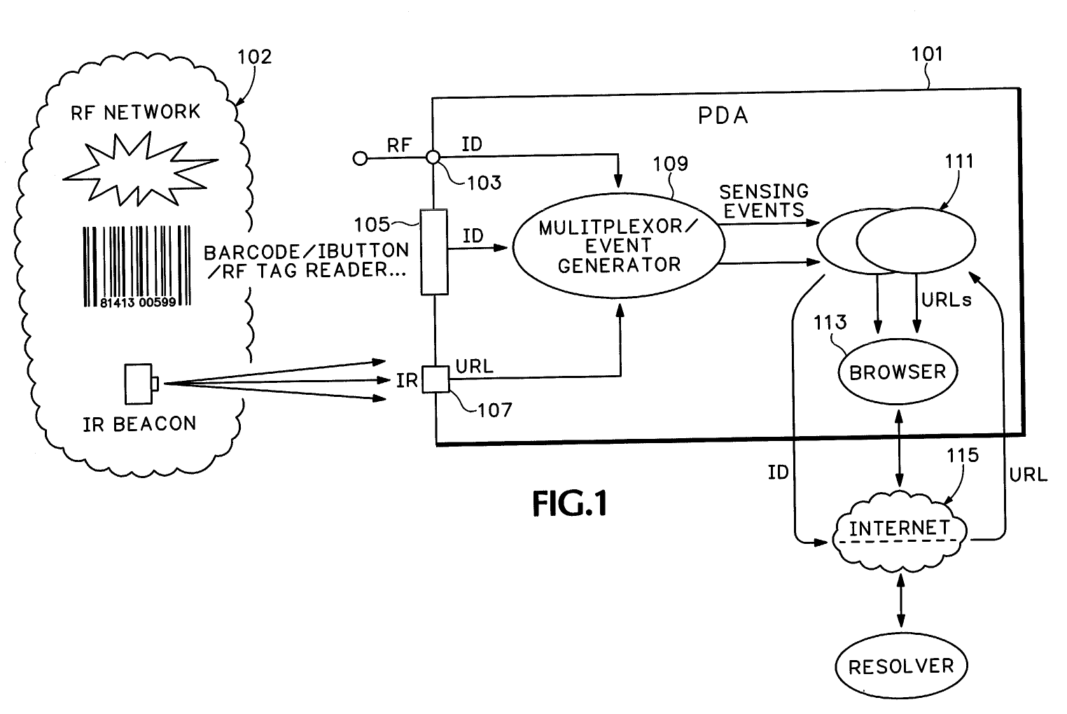

An exemplary embodiment, and alternatives, of the present invention is described in the context of a mobile device that is usually, but not necessarily, a wireless connectivity apparatus. FIG. 1 is a block diagram of a mobile device 101, e.g., an enhanced PDA, configured for obtaining identifiers associated with any given physical object, or entity, in the local environment 102. The PDA is provided with one or more data capture tools such as a radio frequency receiver 103, a tag reader 105, and an infrared data port 107, including known manner electronics and programming associated with same (not shown). In general, it is known that general purpose microprocessors or application specific integrated circuits (ASIC) are used for handling operations and signals associated with the device 101. Identifier signals (represented by arrows labeled “ID” and “URL”) are received by the appropriate capture tools 102, 105, 107, multiplexed by appropriate software or firmware circuitry 109, and distributed to appropriate application programs 111 on-board the device 101. In this particular embodiment, a web browser 113 is included. URL's are sent to the browser 113 accordingly. The Internet is represented as a cloud symbol 115. In the exemplary embodiment, web links utilize the same HyperText Transport Protocol (HTTP) and Uniform Resource Locator (URL) industry protocol standards as the conventional web.

There are two cases of picking up an identifier associated with the Internet example of implementation shown in FIG. 1. In the first case, the identifier is the intended URL. In the second case, the identifier is some data string that has to be sent to a resolver—a service that looks up the corresponding URL and returns it. Each is a different case of obtaining an identifier which is alleged to be that one which the physical object owner has chosen to associate with a specific physical object. Note that the introduction of the use of a resolver case also introduces another authentication problem (see also Background section hereinabove), namely that a malicious person might tamper with the system via a bogus resolver that returns a wrong URL. In either case, there is an identifier allegedly associated with a physical object by the owner in question, and authentication is required.

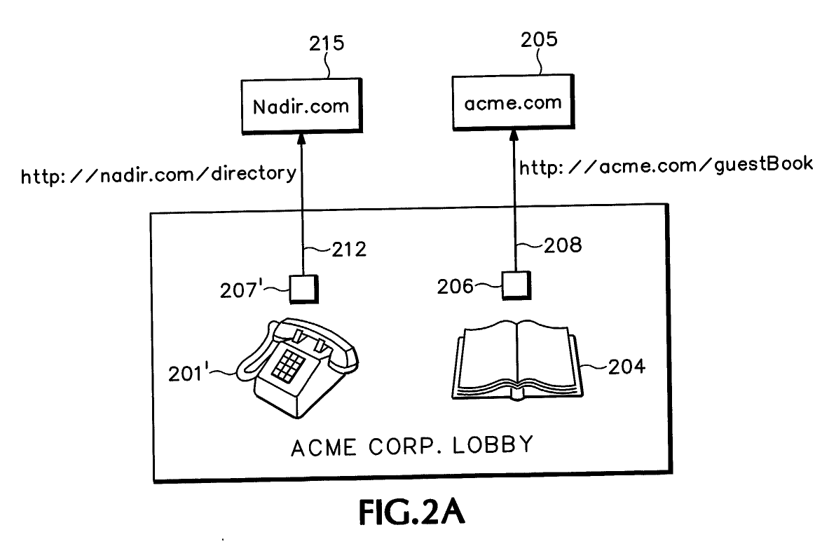

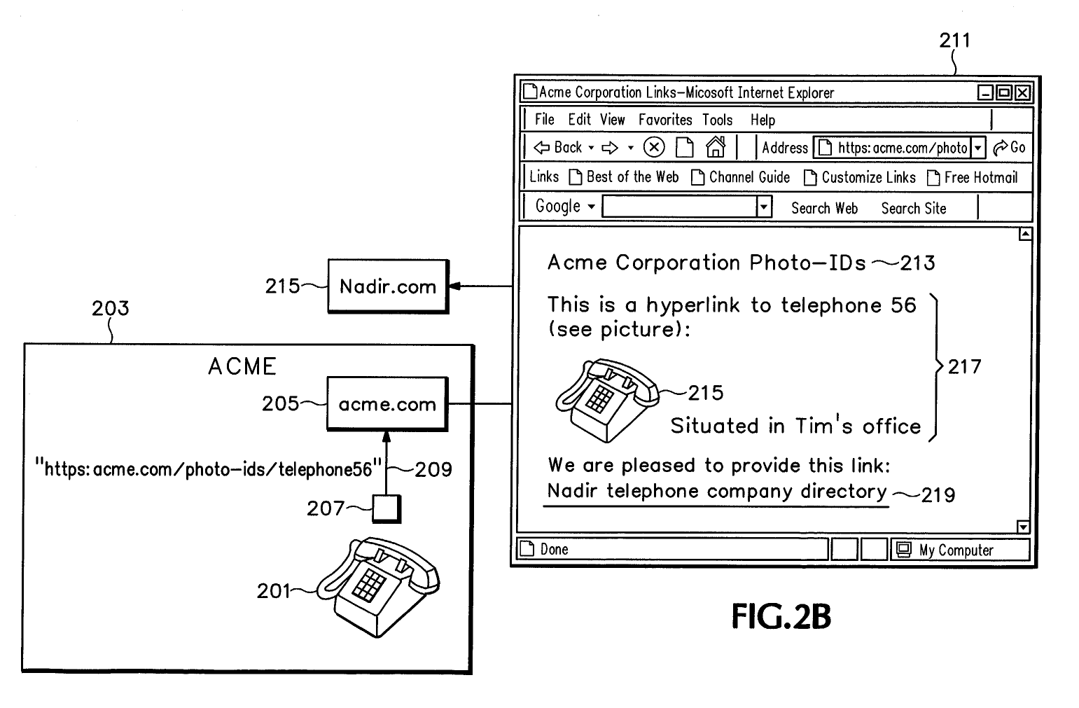

Turning now to FIG. 2A, assume a mobile device 101 (FIG. 1 only) user enters the lobby of the premises of a fictitious business “Acme Corp.” which has at least one Internet resource, here web site 205, illustrated as a circle labeled “acme.com.” In the Acme lobby, the user sights an object-of-interest, e.g., a guest book 204. The guest book 204 has an identifier mechanism 206. The identifier mechanism 206 is associated 208 with Acme's URL link “http://acme.com/guestbook,” where the user can leave a virtual message as an alternative to a handwritten log-in. Another possible object-of-interest for the user is a telephone 201′ with an identifier mechanism 207′. The identifier mechanism 207′ is associated 212 with the fictitious “Nadir” telephone company's on-line directory via link “http://nadir.com/directory” 215. The identifier mechanisms 206, 207′ may be an infrared beacon transmitting the URL to an infrared port of the user's mobile device (FIG. 1, 101) or a barcode encoding a URL read by a barcode scanner (FIG. 1, 105) of the user's mobile device. Again, the beacon or barcode may yield any identifier which is turned into a URL by a resolution service. Before using hyperlinks associated with the objects, the user may desire authentication. FIG. 2B is another simple example of a physical object where authentication of a hyperlink may be desired, another telephone 201 at a fixed location 203, e.g., an office of the fictitious business “Acme Corp.” where each telephone at the business premises is provided with a unique identifier mechanism 207.

In general, three components are added to commonplace business objects such as telephones or guest books to implement an authentication of hyperlinks associated with the object owner's Internet resources.

First, for each Internet resource that Acme wants to be related to a physical object, a web browser (see FIG. 1, element 113) photo-ID web page 211, FIG. 2B—or some similar web page which can accurately identify the physical object associated therewith—is created using known manner commercial or proprietary software, e.g., a physical object with an associated identifier. Here in FIG. 2A, Acme's lobby guest book 204 with identifier 208 and telephone 201′ with identifier 207′ or in FIG. 2B telephone 201 with identifier 207 are to be associated with a linked resource. As a specific example as shown in FIG. 2B, a web page 211 having a URL “https:acme.com/photoids/telephone56” becomes the identifier 207 output from a particular telephone at a particular location, e.g. an infrared beacon signal 209 for the telephone 201, having the business' serial number “56” (e.g., 56/100). Likewise, the object could be a totally unique object (1/1) such as a specific object d'art, the Mona Lisa, in a museum. A purpose of the web page is to make it possible for the user, e.g., the person who visits Acme lobby, FIG. 2A, or office 203, FIG. 2B, to visually, or otherwise, recognize and verify the physical object-of-interest—here, guest book 204 or telephone 201′ in the lobby or telephone 201 in the office 203—to which an associated link is to be established when within range of the related identifier mechanism by a mobile device 101, FIG. 1. Assurance that a true target web page associated with the physical object-of-interest is required. Each photo-id page is provided with “identifying material.” An example of a photo-id web page having photographic identifying material is shown as element 211 in FIG. 2B. In this example, the photo-id page 211 includes (1) the name 213 of the organization asserting one or more links, here shown as “Acme Corporation Photo-IDs,” (2) a photograph 215 of the object associated with the link 209, and (3) textual descriptions of individuating properties 217 of the object, here shown as “This is a hyperlink to telephone 56 (see picture), Situated in Tim's Office.” This photo-id page 211 includes at least one provided hyperlink 219. The latter is referred to as the “target link” 219, that is, it is the link that the mobile device user wants to access once authentication is accomplished. Note that the photo-id page URLs associated with specific objects of the implementing company, Acme Corp., are associated with the associated identifier 207 rather than the actual target URLs.

The second component for authenticating hyperlinks is the use of “https” URLs only, which obviates the need for storing digital signatures at each specific physical object. Thus, each photo-id page is hosted on the business' own web site 205, “acme.com,” in such a way that each can only be reached via an “https” URL; another example might be “https:acme.com/photoids/lobbylguestbook” as shown in FIG. 2A. Integrity between the entire content on the photo-id page 211 and the owner of the domain, Acme Corp., is guaranteed by using only the secure “https” and protocols.

The third component for authenticating hyperlinks is to provided the device 101 browser 113 (FIG. 1) with specific behavior in its use of digital certificates. To guard against acquisition of irrelevant or bogus “https” addresses, the client browser 113 is provided with a special mode of operation whereby it uses only a designated set of certificates to authenticate “https” addresses as true to the physical territory-of-interest, in this example, within the current Acme Corp. building where the device 101 is being used.

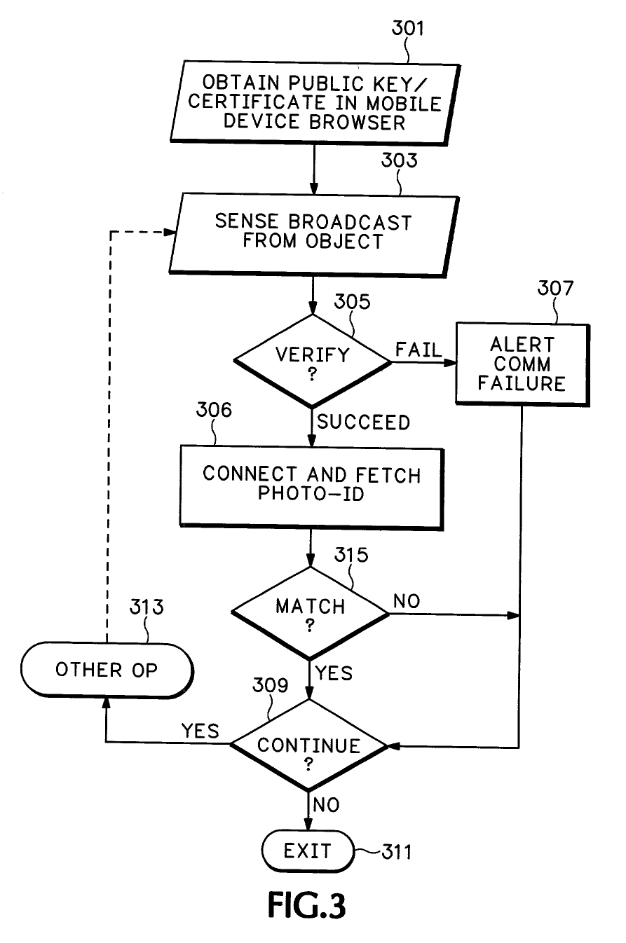

Referring generally to both FIGS. 1, 2A, 2B and now also FIG. 3, in operation, when a mobile device 101 attempts to de-reference an https-URL asserted by the current territory (e.g., within Acme Corp.), its browser 113 first authenticates the website (acme.com) using a certificate previously obtained and establishes communications, step 301. For the purpose of this exemplary embodiment, let the security system being employed be a known manner private key-public key system; the certificate is the public key data for a particular use, e.g., for Acme Corp. (the certificate likely containing a digital signature). Thus, an exemplary beacon broadcast need not contain a digital signature itself, only the https-URL associated with the physical object, e.g., in FIG. 2B, telephone 201. A secure communication is thus established between the browser 113 and the web site 205. In other words, the device 101 must have the designated set of certificates which authenticate the unique URLs for objects-of-interest before being able to de-reference any such associated https-URL into the associated photo-id page 211.

Next, step 303, the user senses and receives the identifier signal via the appropriate tool 103, 105, 107; see e.g., FIG. 1, arrows labeled “Sensing events.”

Then, the browser executes a fetch routine for 305, 306 the photo-id page 211. In this routine, the public key is used to establish the secure a link (e.g., SSL) connection. If the security verification fails, a notice is posted to the device 101 user, step 307, and options for continuing, step 309, provided. The user either terminates, step 311, or can try another object acquisition step 313.

If verification is successful, step 305, Succeeds-path, viz., the https-URL on the physical object-of-interest, here “acme.com/photo-ids/telephone56,” is acquired and the photo-id page 211 appears on the device's display (not shown).

A user option feature is provided to account for mis-targeted objects. If the photo-id page 211 does not match the user's expectation, step 315, No-path, again options for continuing or terminating, step 309, are provided.

Assuming the appropriate photo-id page 211 has been acquired, step 315, Yes-path. The photo-id page provides one or more hyperlinks to the Internet 115. The user can then continue establishing the link, e.g., to “Nadir.com,”, step 313, or attempt another photo-id page acquisition, returning to step 303, or terminate, step 309.

Additionally, to guard against the treat of bogus photo-id pages, the client browser is provided with an optional mode of operation whereby it uses only a designated set of certificates to authenticate photo-id URLs, verifying that they are indeed within the presiding business' territory, e.g., a particular building on a multi-building campus. The alert 307 of authentication failure will be reported if a supposed photo-id URL requires any certificate outside the designated set, even if the browser possesses a certificate for that territory. A way to obtain the designated certificate set is over a secure communication channel placed conveniently on the territory, e.g., downloadable at a specific building's lobby over a constrained infrared channel.

Thus, the exemplary embodiment described in detail shows that the need to store a digital signature (which may be lengthy) in an identifier is eliminated. Should the organization owning the physical objects and Internet domain decide to change target URLs associated with objects, it need only change the link in the photo-id page.

Note some specific problem solutions provided by the embodiments of the present invention. Return to the previous example where a malicious person might attempt to move hyperlink beacons from one physical entity to another, where a vandal could take a museum beacon from beside the Mona Lisa and place it by a Van Gogh. With an embodiment of the present invention in place, the user could detect the wrong link either from the failure of the link to authenticate according to any of the designated certificates, or by comparing the physical object with the photograph of the visual object-of-interest photo-id page. Returning to the previous example of a malicious person reading a beacon, barcode, or the like, and copying it to another transmitter then placed by a different physical entity, with an embodiment of the present invention in place, the user could again detect the wrong link either from the failure of the link to authenticate according to any of the designated certificates or by comparing the physical entity with the photo-id page. Returning to the previous example where a malicious person might attempt to generated spurious links and provide them to users surreptitiously, with an embodiment of the present invention in place, only a user who has internal access to the owner's web site, or one who has stolen the owner's private key, can create such spurious links.

The foregoing description, illustrating certain embodiments and implementations, is not intended to be exhaustive nor to limit the invention to the precise form or to exemplary embodiments disclosed. Obviously, many modifications and variations will be apparent to practitioners skilled in this art. Similarly, any process steps described might be interchangeable with other steps in order to achieve the same result. At least one embodiment was chosen and described in order to best explain the principles of the invention and its best mode practical application, thereby to enable others skilled in the art to understand the invention for various embodiments and with various modifications as are suited to the particular use or implementation contemplated. The scope of the invention can be determined from the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . ”

What is claimed is:

1. A system for identifying a sighted object-of-interest, comprising:
a mobile device, having a program including at least one designated authentication certificate, and having at least one subsystem for sensing identifiers; and
a plurality of objects, each specific object having an related identifier, each related identifier associated with a unique set of identifying material for a said sighted object-of-interest that is cryptographically verifiable with said authentication certificate.

2. The system as set forth in claim 1 comprising:
said program is an Internet browser.

3. The system as set forth in claim 2 comprising:
said identifying material includes Internet hyperlinks.

4. The system as set forth in claim 1 comprising:
said identifying material includes a photograph of said object.

5. The system as set forth in claim 1 comprising:
said identifying material includes identifying textual information for said object.

6. The system as set forth in claim 2 comprising:
said unique set of identifying material includes a browser-accessible address in a system domain-secured HyperText Transport Protocol (HTTP) and Uniform Resource Locator (URL) industry protocol standard format.

7. The system as set forth in claim 1, the program further comprising:
a designated set of certificates to authenticate the set of identifying material including verifying the location of the sighted object-of-interest.

8. A method for authenticating Internet hyperlinks associated with a specific object-of-interest within visual range, the method comprising:
using a browser with at least one digital certificate associated with objects at a given location;
receiving an identifier signal from one of said objects constituting a current said object-of-interest wherein said signal comprises a browser compatible address;
using said certificate, authenticating said identifier signal as associated with said one of said objects; and
displaying identifying material stored at said address wherein said identifying material includes at least one of said Internet hyperlinks.

9. A computer memory comprising:
computer code for Internet browsing;
associated with said code for Internet browsing, computer code for using digital certificates and a specific set of digital certificates associated with a specific location;
associated with said code for using digital certificates, computer code for recognizing object identifier events for objects at said location, wherein an object identifier event is a unique browser-accessible address readable from each of said objects;
associated with said code for recognizing object identifier events, computer code for using said certificates to de-reference said events and access said browser accessible address; and
computer code for displaying identifying material stored at said browser accessible address for an object associated with said object such that said identifying material validates the object and the specific location.

10. The computer memory as set forth in claim 9 wherein said identifying material includes Internet hyperlinks.

11. A method for accessing an Internet hyperlink, the method comprising:
from a location of visual perception of a specific object, reading an identifier associated with the specific object;
verifying said identifier using a predetermined authentication certificate;
receiving a web page defined by said identifier wherein said web page includes information identifying the specific object and the Internet hyperlink.

12. The method as set forth in claim 11 further comprising:
determining if said web page information identifying the specific object matches a specific object-of-interest, and if not, resetting to read another identifier.

13. The method as set forth in claim 11, said verifying further comprising:
when a negative result is determined, providing an indication of a failure.

14. The method as set forth in claim 11, said reading further comprising:
directly reading a URL.

15. The method as set forth in claim 11, said reading further comprising:
reading an identifier that is resolved to a URL.

16. A system for authenticating an https-URL hyperlink associated with a physical object, comprising:
an indentifier mechanism allied with the physical object, having an output signal; and
associated with said output signal, a web page providing identifying material associated with the physical object along said hyperlink associated therewith,
wherein only a designated set of certificates limited to actual physical location of said physical object is used to authenticate the https-URL.

17. The system as set forth in claim 16 wherein said output signal is obtained without requiring a digital signature.

18. The system as set forth in claim 16 further comprising:
a mobile device having a mechanism for receiving the identifier signals and displaying the web page.

19. The system as set forth in claim 16 wherein said output signal is an associated said https-URL.

20. The system as set forth in claim 16 wherein said output signal is associated with a resolver for obtaining an associated said https-URL.
